(19) United States
(12) Patent Application Publication
(10) Pub. No.: US 2005/0118539 A1
(43) Pub. Date: Jun. 2, 2005

(54) Developer being less susceptible to oxidation and method for preparation thereof

(76) Inventor: Minoru Kanno, Sendai-shi (JP)

Correspondence Address: SNIDER & ASSOCIATES, P. O. BOX 27613, WASHINGTON, DC, 20038-7613, US

(21) Appl. No.: 10/478,710

(22) PCT Filed: May 30, 2002
(86) PCT No.: PCT/JP02/05311

(30) Foreign Application Priority Data
May 30, 2001 (JP) 2001-161785

(51) Int. Cl. G03C 5/18

(52) U.S. Cl. 430/434

(57) ABSTRACT

Provided are an oxidation-suppressed developer which is less apt to be oxidized and a method of manufacturing the oxidation-suppressed developer. The oxidation-suppressed developer contains a divalent-trivalent iron salt in a dissolved state. The oxidation-suppressed developer consists essentially of a compound which is obtained by performing neutralization after magnetite is dissolved in concentrated hydrochloric acid and by adding a crystal obtained by concentrating this solution to a concentrated hydrochloric acid solution of magnetite. The divalent-trivalentiron salt is contained in a concentration of 0.25×10⁻⁸ mg/liter to 0.25×10⁻¹⁰ mg/liter.

### TECHNICAL FIELD

The present invention relates to an oxidation-suppressed developer and a method of manufacturing the oxidation-suppressed developer.

### BACKGROUND ART

Conventional developers are distributed in a state of a concentrated developer stock solution having high component concentrations and diluted with water when they are used.

Incidentally, because the dilution of a developer stock solution requires time and labor and variations occur in quality depending on dilution methods, it is desirable that a developer be circulated in a diluted state. However, a developer diluted with water is rapidly oxidized, posing the problem that the storage period is short.

The present invention was made by paying attention to such conventional problems and has as its object the provision of an oxidation-suppressed developer which is less apt to be oxidized and a method of manufacturing the oxidation-suppressed developer.

### DISCLOSURE OF THE INVENTION

To achieve the above-described object, an oxidation-suppressed developer related to the invention is characterized in that the developer contains a divalent-trivalent iron salt in a dissolved state. By way of example, an oxidation-suppressed developer related to the invention contains divalent-trivalent iron salt in a dissolved state by containing pi-water in a volumetric concentration of not less than 0.01 ppm but not more than 100 ppm when converted to a pi-water stock solution with respect to the total volume.

The divalent-trivalent iron salt used is a salt of an iron compound showing a nature which is intermediate between divalent iron and trivalent iron. For example, the divalent-trivalent iron salt may consist essentially of an inorganic salt, such as hydrochloride, sulfate, nitrate, formate, acetate and propionate, or may consist of an organic salt. Pi-water is water which is induced (Ti-transformed) by a divalent-trivalent iron salt. Pi-water stock solutions which are offered commercially by ACM Co., Ltd. as pi-water stock solution types can be suitably used as the pi -water stock solution. Pi-water is obtained by diluting the pi-water stock solution.

Pi-water has the electromagnetic property that this water is activated because a magnetic field is given by the ferrimagnetism of magnetite and the chemical property that this water is activated because the hydrogen bond of water is divided by iron ions contained and its polarization increases.

In another example, an oxidation-suppressed developer related to the invention contains a divalent-trivalent iron salt because the oxidation-suppressed developer contains Fe₃O₄ ions in a volumetric concentration of not less than 0.01 ppb but not more than 100 ppb when converted to a saturated concentrated hydrochloric acid of Fe₃O₄ with respect to the total volume.

In an oxidation-suppressed developer related to the invention, for example, the above-described divalent-trivalent iron salt consists essentially of a compound expressed by the chemical formula Fe⁺²ₘFe⁺³ₙCl₂ₘ₊₃ₙ (where, m and n are each an arbitrary natural number). It is preferred that the above-described divalent-trivalent iron salt be contained in a concentration of 0.25×10⁻⁸ mg/liter to 0.25×10⁻¹⁰ mg/liter. Representatively, the above-described divalent-trivalent iron salt is a compound which is obtained by dissolving ferric chloride in a strongly alkaline aqueous solution and then performing neutralization. As a strongly alkaline aqueous solution it is possible to use sodium hydride, calcium hydride, potassium hydride, lithium hydride, etc.

The above-described divalent-trivalent iron salt may exhibit magnetic properties. Representatively, the above-described divalent-trivalent iron salt may be a compound which is obtained by dissolving magnetite in concentrated hydrochloric acid, thereafter performing neutralization, and adding crystals obtained by concentrating this solution to a concentrated hydrochloric acid solution of magnetite. It is preferred that, in an oxidation-suppressed developer related to the invention, this compound be contained in a concentration of 0.25×10⁻⁸ mg/liter to 0.25×10⁻¹⁰ mg/liter. It is preferred that the concentrated hydrochloric acid solution of magnetite be a solution in which magnetite is half-dissolved in concentrated hydrochloric acid. As a method of manufacturing a divalent-trivalent iron salt which exhibits magnetic properties, more concretely, it is preferred that this divalent-trivalent iron salt be manufactured by dissolving magnetite in concentrated hydrochloric acid, neutralizing this solution with a strong alkali, and adding crystals which are obtained by concentrating this neutralized solution to a solution in which magnetite is half-dissolved in concentrated hydrochloric acid. As a strong alkali to be used, for example, sodium hydride, calcium hydride, potassium hydride and lithium hydride are preferred.

By immersing ceramic solid matter containing a divalent-trivalent iron salt in water and using the water, an oxidation-suppressed developer related to the invention may contain the divalent-trivalent iron salt. A divalent-trivalent iron salt may exhibit magnetic properties. A divalent-trivalent iron salt can be obtained by the above-described method. A ceramic solid matter containing a divalent-trivalent iron salt can be manufactured, for example, by mixing a divalent-trivalent iron salt or water containing a divalent-trivalent iron salt with clay and sintering the mixture at about 800 to 1100° C. for about 10 to 30 hours. The amount of a divalent-trivalent iron salt or water containing a divalent-trivalent iron salt mixed with clay can be appropriately selected.

Because an oxidation-suppressed developer related to the invention contains a divalent-trivalent iron salt, oxidation is suppressed and coloring associated with oxidation and other deterioration phenomena are suppressed. For this reason, in an oxidation-suppressed developer related to the invention, storage stability is improved and distribution in a diluted state becomes possible. In an oxidation-suppressed developer related to the invention, particularly, pi-water, Fe₃O₄ ions or a compound expressed by the chemical formula Fe⁺²ₘFe⁺³ₙCl₂ₘ₊₃ₙ (where, m and n are each an arbitrary natural number) is contained in the above-described volumetric concentration and, therefore, oxidation is suppressed and coloring associated with oxidation and other deterioration phenomena are suppressed.

An oxidation-suppressed developer related to the invention may consist of a fast developer or a color developer. An oxidation-suppressed developer related to the invention may be a developer for a reversal film, a positive, a negative, an X-ray film, a movie film, a color photograph, a black-and-white picture and other all types of photograph.

It is preferred that a fast developer consist essentially of 90 to 95% water by weight, 1 to 5% potassium sulfite by weight, 1 to 5% potassium carbonate by weight, 1 to 5% potassium hydroquinone monosulfonate by weight and less than 1% sodium carbonate by weight.

It is preferred that a color developer consist essentially of 90 to 95% water by weight, 1 to 5% tripotassium phosphate by weight, 1 to 5% 4-(N-ethyl-N-2-mathane sulfonylaminoethyl)-2-methyl phenylenediamine sesquisulfate monohydrate by weight, less than 1% sodium sulfite by weight and less than 0.5% potassium hydroxide by weight.

When an oxidation-suppressed developer related to the invention which uses pi-water consists of a fast developer, the oxidation-suppressed developer contains pi-water preferably in a volumetric concentration of not less than 0.01 ppm but not more than 100 ppm and more preferably in a volumetric concentration of not less than 0.1 ppm but not more than 10 ppm when converted to a pi-water stock solution with respect to the total volume.

In the case of a fast developer, the effect on oxidation suppression is small if the volumetric concentration of pi-water converted to a pi-water stock solution is less than 0.01 ppm, whereas an increase in the effect on oxidation suppression is not observed regardless of an increase in the concentration if the volumetric concentration exceeds 100 ppm, and the effect on oxidation suppression is especially great in the range of not less than 0.1 ppm but not more than 10 ppm. This is the reason for the limitation of the volumetric concentration of pi-water in the case of a fast developer.

When an oxidation-suppressed developer related to the invention which uses Fe₃O₄ consists of a fast developer, the oxidation-suppressed developer contains Fe₃O₄ ions preferably in a volumetric concentration of not less than 0.01 ppb but not more than 100 ppb and more preferably in a volumetric concentration of not less than 0.1 ppb but not more than 10 ppb when converted to a saturated concentrated hydrochloric acid solution of Fe₃O₄ with respect to the total volume.

In the case of a fast developer, the effect on the suppression of oxidation is small if the volumetric concentration of Fe₃O₄ ions converted to a saturated concentrated hydrochloric acid solution of Fe₃O₄ is less than 0.01 ppb, whereas an increase in the effect on the suppression of oxidation is not observed regardless of an increase in the concentration if the volumetric concentration exceeds 100 ppb, and the effect on the suppression of oxidation is especially great in the range of not less than 0.1 ppb but not more than 10 ppb. This is the reason for the limitation of the volumetric concentration of pi-water in the case of a fast developer.

When an oxidation-suppressed developer related to the invention which uses pi-water consists of a color developer, the oxidation-suppressed developer contains pi-water preferably in a volumetric concentration of exceeding 0.01 ppm but not more than 50 ppm and more preferably in a volumetric concentration of not less than 1 ppm but not more than 15 ppm when converted to a pi-water stock solution with respect to the total volume.

In the case of a color developer, the effect on the suppression of oxidation is small if the volumetric concentration of pi-water converted to a pi-water stock solution is not more than 0.01 ppm, whereas the effect on the suppression of oxidation decreases regardless of an increase in the concentration if the volumetric concentration exceeds 50 ppm, and the effect on the suppression of oxidation is especially great in the range of not less than 1 ppm but not more than 15 ppm. This is the reason for the limitation of the volumetric concentration of pi-water in the case of a color developer.

When an oxidation-suppressed developer related to the invention which uses Fe₃O₄ consists of color developer, the oxidation-suppressed developer contains Fe₃O₄ ions preferably in a volumetric concentration of exceeding 0.01 ppb but not more than 50 ppb and more preferably in a volumetric concentration of not less than 1 ppb but not more than 15 ppb when converted to a saturated concentrated hydrochloric acid solution of Fe₃O₄ with respect to the total volume.

In the case of a color developer, the effect on the suppression of oxidation is small if the volumetric concentration of Fe₃O₄ ions converted to a saturated concentrated hydrochloric acid solution of Fe₃O₄ is not more than 0.01 ppb, whereas an increase in the effect on oxidation suppression is not observed regardless of an increase in the concentration if the volumetric concentration exceeds 50 ppb, and the effect on oxidation suppression is especially great in the range of not less than 1 ppb but not more than 15 ppb. This is the reason for the limitation of the volumetric concentration of pi-water in the case of a color developer.

A method of manufacturing an oxidation-suppressed developer related to the invention is characterized in that a solution of a divalent-trivalent iron salt is added to developer components. By way of example, in a method of manufacturing an oxidation-suppressed developer related to the invention, a solution of a divalent-trivalent iron salt is added by adding pi-water to developer components so as to obtain a volumetric concentration of not less than 0.01 ppm but not more than 100 ppm when converted to a pi-water stock solution with respect to the total volume. In another example, in a method of manufacturing an oxidation-suppressed developer related to the invention, a solution of a divalent-trivalent iron salt is added by adding an aqueous solution of Fe₃O₄ to developer components so as to obtain a volumetric concentration of not less than 0.01 ppb but not more than 100 ppb when converted to a saturated concentrated hydrochloric acid solution of Fe₃O₄ with respect to the total volume. Incidentally, the aqueous solution of Fe₃O₄ may contain hydrochloric acid.

In a method of manufacturing an oxidation-suppressed developer related to the invention, for example, the above-described divalent-trivalent iron salt consists essentially of a compound expressed by the chemical formula Fe⁺²ₘFe⁺³ₙCl₂ₘ₊₃ₙ (where, m and n are each an arbitrary natural number) and is added to developer components so as to obtain an aqueous solution in a concentration of 0.25×10⁻⁸ mg/liter to 0.25×10⁻¹⁰ mg/liter.

By a method of manufacturing an oxidation-suppressed developer related to the invention, it is possible to manufacture the above-described oxidation-suppressed developer related to the invention.

Representatively, the above-described divalent-trivalent iron salt is a compound which is obtained by dissolving ferric chloride in a strongly alkaline aqueous solution and thereafter performing neutralization.

The above-described divalent-trivalent iron salt may exhibit magnetic properties. Representatively, this compound is also a compound which is obtained by dissolving magnetite in concentrated hydrochloric acid, thereafter performing neutralization, and adding a crystal obtained by concentrating this solution to a concentrated hydrochloric acid solution of magnetite. Also this compound is added to developer components so as to obtain an aqueous solution in a concentration of 0.25×10⁻⁸ mg/liter to 0.25×10⁻¹⁰ mg/liter.

When the above-described divalent-trivalent iron salt is dissolved in 1 liter of water in an amount of 0.25 mg, for example, it is possible to dilute the solution about 10,000 times to about 100,000 times as a stock solution and this stock solution can be further diluted about 10,000 times to about 100,000 times for use as prepared water for photographic development. By using this prepared water in place of water which is usually used for the dilution of a concentrated developer for photographic development, it is possible to manufacture the above-described oxidation-suppressed developer related to the invention.

### BRIEF DESCRIPTION OF THE DRAWINGS

FIG. 1 is a graph showing the effect of pi-water on the sulfite ions of a fast developer in Embodiment 1 of the present invention. In FIG. 1, the numeral 1 denotes pi-water and the numeral 2 denotes an object of comparison; and

FIG. 2 is a graph showing the effect of pi-water on the sulfite ions of a color developer in Embodiment 3 of the present invention. In FIG. 2, the numeral 3 denotes pi-water and the numeral 4 denotes an object of comparison.

### BEST MODE FOR CARRYING OUT THE INVENTION

### EMBODIMENT 1

A concentrated solution of a commercially available fast developer was diluted with water and a usable developer was prepared. By adding a pi-water stock solution to this developer in varied concentrations, an investigation was made into the effect on the concentration of sulfite ions contained in the developer. A commercially available product (trade name: “Kodak Fast Developer replenisher, Process E-6” produced and sold by Kodak Japan) was used as the fast developer. The fast developer consisted of 92% water by weight, 2.5% potassium sulfite by weight, 2.5% potassium carbonate by weight, 2.5% potassium hydroquinone monosulfonate by weight and 0.5% sodium carbonate byweight. Acommerciallyavailablepi-water stock solution (product name: “CF” made and sold by ACM Co., Ltd.) was used as the pi-water stock solution.

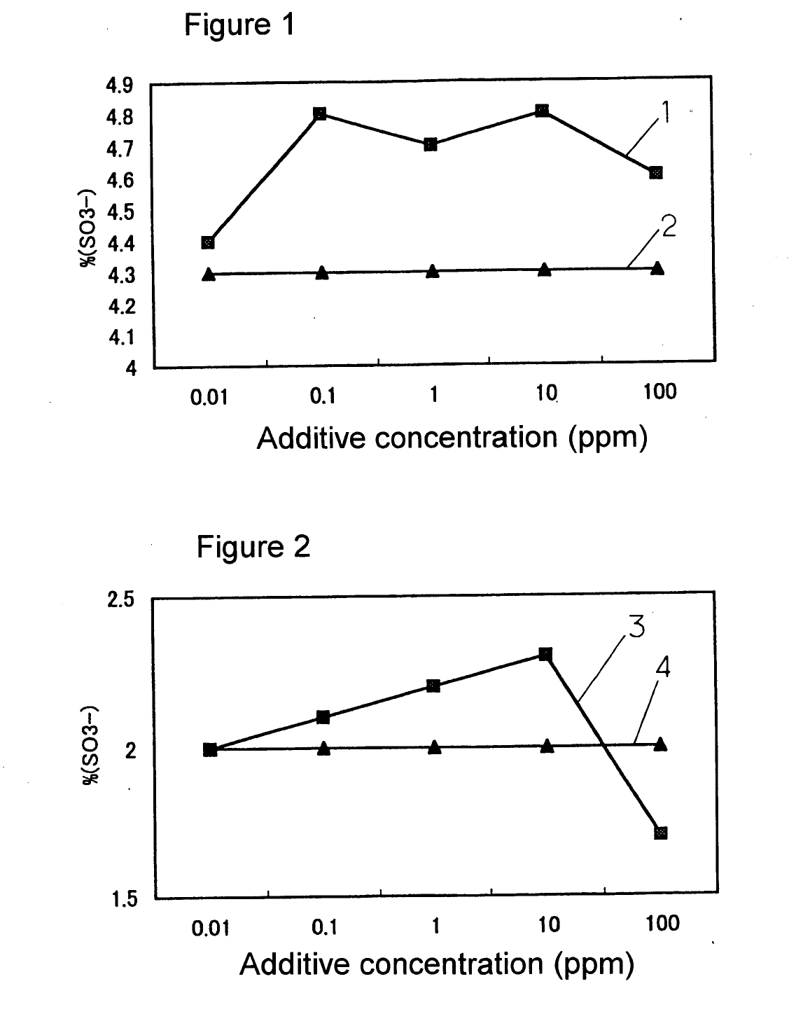

Developers containing the pi-water stock solution in amounts of 0.01 ppm, 0.1 ppm, 1 ppm, 10 ppm and 100 ppm and a developer not containing the pi-water stock solution for comparison were prepared. For these 6 types of developers, their sulfate ion concentrations after a lapse of 48 hours after the preparation were measured. The measurement results are shown in the graph of FIG. 1.

As shown in FIG. 1, it became apparent that the sulfate ion concentration is higher in a case where the pi-water stock solution is contained in a volumetric concentration of not less than 0.01 ppm but not more than 100 ppm (denoted by the numeral 1 in FIG. 1) than in the object of comparison which does not contain the pi-water stock solution (denoted by the numeral 2 in FIG. 1) and that, in particular, when the pi-water stock solution is contained in a volumetric concentration of not less than 0.1 ppm but not more than 10 ppm, the sulfate ion concentration is notably high, demonstrating that the developer is less apt to be oxidized.

The degree of discoloring by the oxidation after a lapse of 48 hours after the preparation was observed. In the object of comparison not containing the pi-water stock solution, the degree of discoloration was so great that it could not be used as a developer. In contrast, in the developers containing the pi-water sock solution in amounts of 0.1 ppm, 1 ppm, 10 ppm and 100 ppm, the degree of discoloring was such that these developers bore use although they had discolored brown.

### EMBODIMENT 2

A concentrated solution of a commercially available fast developer was diluted with water and a usable developer was prepared. By adding a hydrochloric acid solution of Fe₃O₄ to this developer in varied concentrations, an investigation was made into the effect on the concentration of sulfite ions contained in the developer. A commercially available product (trade name: “Kodak Fast Developer Replenisher, Process E-6” produced and sold by Kodak Japan) was used as the fast developer. The fast developer consisted of 92% water by weight, 2.5% potassium sulfite by weight, 2.5% potassium carbonate by weight, 2.5% potassium hydroquinone monosulfonate by weight and 0.5% sodium carbonate by weight. A solution obtained by adding 1 ml of a saturated concentrated hydrochloric acid solution of Fe₃O₄ to 1000 ml of distilled water and stirring the mixture was used as the hydrochloric acid solution of Fe₃O₄.

Developers containing the hydrochloric acid solution of Fe₃O₄ in amounts of 0.01 ppm, 0.1 ppm, 1 ppm, 10 ppm and 100 ppm and a developer not containing the hydrochloric acid solution of Fe₃O₄ for comparison were prepared. For these 6 types of developers, their sulfate ion concentrations after a lapse of 48 hours after the preparation were measured. The measurement results were almost close to those shown in the graph of FIG. 1.

That is, it became apparent that the sulfate ion concentration is higher in a case where Fe₃O₄ions are contained in a volumetric concentration of not less than 0.01 ppb but not more than 100 ppb when converted to the saturated concentrated hydrochloric acid solution of Fe₃O₄ than in the object of comparison which does not contain Fe₃O₄ ions and that, in particular, when Fe₃O₄ ions are contained in a volumetric concentration of not less than 0.1 ppb but not more than 10 ppb when converted to the saturated concentrated hydrochloric acid solution of Fe₃O₄, the sulfate ion concentration is notably high, demonstrating that the developer is less apt to be oxidized.

The degree of discoloring by the oxidation after a lapse of 48 hours after the preparation was observed. In the object of comparison not containing Fe₃O₄ ions, the degree of discoloration was so great that it could not be used as a developer. In contrast, in the developers containing Fe₃O₄ ions in amounts of 0.1 ppb, 1 ppb, 10 ppb and 100 ppb when converted to the saturated concentrated hydrochloric acid solution of Fe₃O₄, the degree of discoloring was such that these developers bore use although they had discolored brown.

### EMBODIMENT 3

Two types of concentrated solutions of a commercially available color developer were mixed and diluted with water and a usable developer was prepared. By adding a pi-water stock solution to this developer in varied concentrations, an investigation was made into the effect on the concentration of sulfite ions contained in the developer. A commercially available product (trade name: “Kodak Color Developer Replenisher, Process E-6” produced and sold by Kodak Japan) was used as the color developer. The color developer consisted of 92% water by weight, 2% tripotassium phosphate by weight, 3% 4-(N-ethyl-N-2-mathane sulfonylaminoethyl)-2-methyl phenylenediamine sesquisulfate monohydrate by weight, 0.8% sodium sulfite by weight and 0.3% potassium hydroxide by weight. A commercially available pi-water stock solution (product name: “CF” made and sold by ACM Co., Ltd.) was used as the pi-water stock solution.

Developers containing the pi-water stock solution in amounts of 0.01 ppm, 0.1 ppm, 1 ppm, 10 ppm and 100 ppm and a developer not containing the pi-water stock solution for comparison were prepared. For these 6 types of developers, their sulfate ion concentrations after a lapse of 48 hours after the preparation were measured. The measurement results are shown in the graph of FIG. 2.

As shown in FIG. 2, it became apparent that the sulfate ion concentration is higher in a case where the pi-water stock solution is contained in a volumetric concentration of exceeding 0.01 ppm but not more than 50 ppm (denoted by the numeral 3 in FIG. 2) than in the object of comparison which does not contain the pi-water stock solution (denoted by the numeral 4 in FIG. 2) and that, in particular, when the pi-water stock solution is contained in a volumetric concentration of not less than 1 ppm but not more than 15 ppm, the sulfate ion concentration is notably high, demonstrating that the developer is less apt to be oxidized.

The degree of discoloring by the oxidation after a lapse of 48 hours after the preparation was observed. In the object of comparison not containing the pi-water stock solution, the degree of discoloration was so great that it could not be used as a developer. In contrast, in the developers containing the pi-water sock solution in amounts of 1 ppm and 10 ppm, the degree of discoloring was such that these developers bore use although they had discolored brown.

### EMBODIMENT 4

Two types of concentrated solutions of a commercially available color developer were mixed and diluted with water and a usable developer was prepared. By adding a hydrochloric acid solution of Fe₃O₄ to this developer in varied concentrations, an investigation was made into the effect on the concentration of sulfite ions contained in the developer. A commercially available product (trade name: “Kodak Color Developer Replenisher, Process E-6” produced and sold by Kodak Japan) was used as the color developer.

The color developer consisted of 92% water by weight, 2% tripotassium phosphate by weight, 3% 4-(N-ethyl-N-2-mathane sulfonylaminoethyl)-2-methyl phenylenediamine sesquisulfate monohydrate by weight, 0.8% sodium sulfite by weight and 0.3% potassium hydroxide by weight. A solution obtained by adding 1 ml of a saturated concentrated hydrochloric acid solution of Fe₃O₄ to 1000 ml of distilled water and stirring the mixture was used as the hydrochloric acid solution of Fe₃O₄.

Developers containing a hydrochloric acid solution of Fe₃O₄ in amounts of 0.01 ppm, 0.1 ppm, 1 ppm, 10 ppm and 100 ppm and a developer not containing the hydrochloric acid solution of Fe₃O₄ for comparison were prepared. For these 6 types of developers, their sulfate ion concentrations after a lapse of 48 hours after the preparation were measured. The measurement results were almost close to those shown in the graph of FIG. 2.

That is, it became apparent that the sulfate ion concentration is higher in a case where Fe₃O₄ ions are contained in a volumetric concentration of exceeding 0.01 ppb but not more than 50 ppb when converted to the saturated concentrated hydrochloric acid solution of Fe₃O₄ than in the object of comparison which does not contain Fe₃O₄ ions and that, in particular, when Fe₃O₄ ions are contained in a volumetric concentration of not less than 1 ppb but not more than 15 ppb when converted to the saturated concentrated hydrochloric acid solution of Fe₃O₄, the sulfate ion concentration is notably high, demonstrating that the developer is less apt to be oxidized.

The degree of discoloring by the oxidation after a lapse of 48 hours after the preparation was observed. In the object of comparison not containing Fe₃O₄ ions, the degree of discoloration was so great that it could not be used as a developer. In contrast, in the developers containing Fe₃O₄ ions in amounts of 1 ppb and 10 ppb when converted to the saturated concentrated hydrochloric acid solution of Fe₃O₄, the degree of discoloring was such that these developers bore use although they had discolored brown.

### EMBODIMENT 5

In this embodiment, 1.0 mg of ferric chloride was put to 100 ml of an aqueous solution of 0.5 N NaOH and dissolved by stirring the aqueous solution, and the aqueous solution was allowed to stand for 24 hours. Insoluble matter formed in the aqueous solution was removed. This solution was neutralized with hydrochloric acid, then concentrated under reduced pressure, and dried in a decicator under the formation of crystals. The crystals thus obtained were remelted by adding 50 ml of an aqueous solution of 80% isopropyl alcohol by weight, the aqueous solution was concentrated under reduced pressure to remove the solvent, and the crystals were dried. By repeating the treatment steps of remelting, concentration and drying several times, 0.25 mg of crystals (divalent-trivalent iron salt) was obtained. The crystals were dissolved in about 1 liter of distilled water and the solution was further diluted about 10,000 times, whereby a pi-water stock solution containing a divalent-trivalent iron salt was obtained. This stock solution was diluted about 10,000 times by use of distilled water and prepared water for photographic development was obtained.

A commercially available concentrated solution for development (manufacturer: Kodak Japan, trade name: “Kodak Fast Developer Replenisher, Process E-6 and Process E-6AR”) was diluted about 2.5 times by use of this prepared water and used as a developer. Also, this commercially available concentrated solution for development was diluted about 3.5 times and used as a developer. As a result, all developers sufficiently bore use even when 48 hours elapsed after the dilution. Incidentally, in a comparative example in which distilled water was used in place of pi-water, the developer could not bear use when 48 hours elapsed after the dilution. Similar results were obtained also in a case where another commercially available concentrated solution (manufacturer: Kodak Japan, trade name: “Kodak Color Developer Replenisher, Process E-6”) was used in place of the above-described concentrated solutions for development.

### EMBODIMENT 6

In this embodiment, 0.1 g of magnetite was put to 10 ml of concentrated hydrochloric acid and dissolved by stirring the solution, and the solution was allowed to stand for 24 hours. This solution was neutralized by adding 25 ml of aqueous solution of 2N sodium hydride and allowing the solution to stand for 24 hours. This solution was concentrated under reduced pressure to precipitate crystals, and the crystals were dried in an air oven. The crystals were put to 10 ml of ethyl alcohol and rinsed. By repeating this rinsing operation several times, the crystals were refined to obtain desired crystals. The yield of the crystals was 0.88 g. Next, 5 g of magnetite was put to 10 ml of concentrated hydrochloric acid and half-dissolved by stirring the solution. The crystals obtained in the above-described process were added to this half-solution in an amount of 0.1 g and thoroughly stirred and the solution was allowed to stand for 24 hours. A supernatant liquid of this solution was separated from insoluble magnetite by the decantation process and a solution of divalent-trivalent iron salt which exhibits magnetic properties was obtained. This solution of divalent-trivalent iron salt was dissolved in about 1 liter of distilled water and further diluted about 10,000 times, and a divalent-trivalent iron salt containing stock solution which exhibits magnetic properties was obtained. This stock solution was diluted about 10,000 times with distilled water and prepared water for photographic development was obtained. A developer for photographic development is prepared by use of this prepared water.

A commercially available concentrated solution for development (manufacturer: Kodak Japan, trade name: “Kodak Fast Developer Replenisher, Process E-6 and Process E-6AR”) was diluted about 2.5 times by use of this prepared water and used as a developer. Also, this commercially available concentrated solution for development was diluted about 3.5 times and used as a developer. As a result, all developers sufficiently bore use even when 48 hours elapsed after the dilution. Incidentally, in a comparative example in which distilled water was used in place of pi-water, the developer could not bear use when 48 hours elapsed after the dilution. Similar results were obtained also in a case where another commercially available concentrated solution (manufacturer: Kodak Japan, trade name: “Kodak Color Developer Replenisher, Process E-6”) was used in place of the above-described concentrated solutions for development.

Industrial Applicability

According to the present invention, it is possible to provide an oxidation-suppressed developer which is less apt to be oxidized and a method of manufacturing the oxidation-suppressed developer. For this reason, the storage period of an oxidation-suppressed developer is prolonged and it is possible to circulate a developer in a usable state without dilution. As a result of this, it is possible to save the time and labor for preparing a developer by diluting a developer stock solution and, at the same time, the quality of a developer can be kept constant.

1. An oxidation-suppressed developer, characterized in that the oxidation-suppressed developer contains a divalent-trivalent iron salt in a dissolved state.

2. The oxidation-suppressed developer according to claim 1, characterized in that the oxidation-suppressed developer contains pi-water in a volumetric concentration of not less than 0.01 ppm but not more than 100 ppm when converted to a pi-water stock solution with respect to the total volume.

3. The oxidation-suppressed developer according to claim 1, characterized in that said oxidation-suppressed developer contains Fe₃O₄ ions in a volumetric concentration of not less than 0.01 ppb but not more than 100 ppb when converted to a saturated concentrated hydrochloric acid of Fe₃O₄ with respect to the total volume.

4. The oxidation-suppressed developer according to claim 1, characterized in that said divalent-trivalent iron salt consists essentially of a compound expressed by the chemical formula Fe⁺²ₘFe⁺³ₙCl₂ₘ₊₃ₙ (where, m and n are each an arbitrary natural number).

5. The oxidation-suppressed developer according to claim 4, characterized in that said divalent-trivalent iron salt is contained in a concentration of 0.25×10⁻⁸ mg/liter to 0.25×10⁻¹⁰ mg/liter.

6. The oxidation-suppressed developer according to claim 5, characterized in that said divalent-trivalent iron salt is a compound which is obtained by dissolving ferric chloride in a strongly alkaline aqueous solution and thereafter performing neutralization.

7. The oxidation-suppressed developer according to claim 1, characterized in that said divalent-trivalent iron salt exhibits magnetic properties.

8. The oxidation-suppressed developer according to claim 7, characterized in that said divalent-trivalent iron salt is a compound which is obtained by dissolving magnetite in concentrated hydrochloric acid, thereafter performing neutralization, and adding a crystal obtained by concentrating this solution to a concentrated hydrochloric acid solution of magnetite.

9. The oxidation-suppressed developer according to claim 1, characterized in that the oxidation-suppressed developer consists essentially of a fast developer.

10. The oxidation-suppressed developer according to claim 1, characterized in that the oxidation-suppressed developer consists essentially of a color developer.

11. A method of manufacturing an oxidation-suppressed developer, characterized in that a solution of a divalent-trivalent iron salt is added to developer components.

12. The method of manufacturing an oxidation-suppressed developer according to claim 11, characterized in that pi-water is added to developer components so as to obtain a volumetric concentration of not less than 0.01 ppm but not more than 100 ppm when converted to a pi-water stock solution with respect to the total volume.

13. The method of manufacturing an oxidation-suppressed developer according to claim 11, characterized in that an aqueous solution of Fe₃O₄ is added to developer components so as to obtain a volumetric concentration of not less than 0.01 ppb but not more than 100 ppb when converted to a saturated concentrated hydrochloric acid of Fe₃O₄ with respect to the total volume.

14. The method of manufacturing an oxidation-suppressed developer according to claim 11, characterized in that that said divalent-trivalent iron salt consists essentially of a compound expressed by the chemical formula Fe⁺²ₘFe⁺³ₙCl₂ₘ₊₃ₙ (where, m and n are each an arbitrary natural number) and is added to developer components so as to obtain an aqueous solution in a concentration of 0.25×10⁻⁸ mg/liter to 0.25×10⁻¹⁰ mg/liter.

15. The oxidation-suppressed developer according to claim 6, characterized in that the oxidation-suppressed developer consists essentially of a fast developer.

16. The oxidation-suppressed developer according to claim 7, characterized in that the oxidation-suppressed developer consists essentially of a fast developer.

17. The oxidation-suppressed developer according to claim 8, characterized in that the oxidation-suppressed developer consists essentially of a fast developer.

18. The oxidation-suppressed developer according to claim 6, characterized in that the oxidation-suppressed developer consists essentially of a color developer.

19. The oxidation-suppressed developer according to claim 7, characterized in that the oxidation-suppressed developer consists essentially of a color developer.

20. The oxidation-suppressed developer according to claim 8, characterized in that the oxidation-suppressed developer consists essentially of a color developer.
